(19) United States
(12) Patent Application Publication
(10) Pub. No.: US 2013/0332652 A1
(43) Pub. Date: Dec. 12, 2013

(54) COMPUTER SYSTEM AND METHOD FOR CONTROLLING COMPUTER SYSTEM

(71) Applicant: Shinichi Hayashi, Yokohama (JP)

(72) Inventor: Shinichi Hayashi, Yokohama (JP)

(73) Assignee: Hitachi, Ltd., Tokyo (JP)

(21) Appl. No.: 13/581,426

(22) PCT Filed: Jun. 11, 2012
(86) PCT No.: PCT/JP2012/064871

§ 371 Date: Aug. 27, 2012

(51) Int. Cl. G06F 12/08

(52) U.S. Cl. 711/103; 711/118; 711/E12.017; 711/E12.008

(57) ABSTRACT

The present invention provides a computer system comprising a server and a storage system having a compression function, wherein the server includes a control unit and a cache, and the storage system has a storage area provided by a plurality of storage devices. When a designated data of a received read request is stored in the cache, the control unit of the server returns the stored data as a response to the read request, and when the designated data is not stored in the cache, the control unit acquires the designated data compressed via the compression function and stored in the storage area in the compressed state from the storage system, decompresses the acquired compression data, and returns the same as a response to the read request.

### TECHNICAL FIELD

The present invention relates to cache control, and more specifically, relates to the art of efficiently utilizing limited cache space.

### BACKGROUND ART

Recently, flash memory drives mounted on servers have become popular. Flash memory drives have higher performances than HDDs (Hard Disk Drives). In a shared storage system having HDDs, the read performance of the system can be improved significantly by providing a flash memory drive as a read cache to the server. In order to further enhance the read performance, it is necessary to improve the cache hit rate. In order to do so, a larger number of flash memory drives must be mounted on the server.

However, there is a limit in the number of slots for mounting flash memory drives. A shared storage system provides a capacity of a few hundred terabytes to a few petabytes to the server, while on the other hand, a single flash memory drive provides a capacity of a few hundred gigabytes to a few terabytes. Since the capacity of the flash memory drive is smaller than the capacity of the volume provided by the shared storage system, it is necessary to utilize the capacity of the flash memory drive efficiently in order to improve the read performance.

One method for utilizing the capacity of the flash memory drive efficiently is the compression of cache data. By compressing the data before caching the same, a larger amount of data can be stored in the flash memory drive. However, since the compression of data must be executed in the server and such compression processing consumes a large amount of memories and CPU (Central Processing Unit), it may have an adverse effect on the performance of the application operating in the server (patent literature 1).

Further, it is possible to acquire a snapshot of the volume in which the OS or the application is stored for arranging the virtual machine, and to allocate the snapshot to the virtual machine. At this time, the volume allocated to the virtual machine refers to the same volume acting as the base (patent literature 2).

### CITATION LIST

### Patent Literature

### [PTL 1]

United States Patent Application Publication No. US 2005/0015374

### [PTL 2]

United States Patent Application Publication No. US 2011/0088029

### SUMMARY OF INVENTION

### Technical Problem

The object of the present invention is to utilize a flash memory drive disposed on a server as a cache, which is capable of caching as much data as possible without causing an adverse effect on the performance of the application operating in the server.

Actually, the present invention characterizes in performing the compression processing of data to be cached without applying load on the server. Furthermore, in a system where multiple virtual volumes are associated with a single base volume, the present invention enables to prevent the same data from being stored in a duplicated manner in the cache.

### Solution to Problem

One aspect of the present invention disclosed in the present application is as follows. The present invention provides a computer system and a method for controlling the computer system comprising a server and a storage system having a compression function, wherein the server includes a control unit and a cache, and the storage system has a storage area provided by a plurality of storage devices. When a designated data of a received read request is stored in the cache, the control unit of the server returns the stored data as a response to the read request, and when the designated data is not stored in the cache, the control unit acquires the designated data compressed via the compression function and stored in the storage area in the compressed state from the storage system, decompresses the acquired compression data, and returns the same as a response to the read request.

The present invention also provides a computer system having a server including a control unit and a cache, and provides a plurality of virtual machines, wherein a storage system provides a plurality of virtual volumes each associated with each of the plurality of virtual machines, and one base volume and a differential volume associated with the plurality of virtual volumes. The differential volume stores a change data of the data stored in the base volume by the virtual machine associated with the plurality of virtual volumes. When data stored in a designated area of a read request from the one virtual machine is not stored in the cache, a correspondence relationship information between the virtual volume, the base volume and the differential volume is acquired from the storage system, and if it is determined based on the correspondence relationship information that the data designated by the read request is already stored in the cache, the data will not be stored in the cache.

### Advantageous Effects of Invention

According to the present invention, the cache capacity of the server can be utilized efficiently without applying heavy load on the server, such as compression processing. Furthermore, since data can be transmitted in the compressed state when transmitting data from the storage system to the server, the load applied on the SAN can be cut down.

### BRIEF DESCRIPTION OF DRAWINGS

FIG. 1 illustrates an outline of embodiment 1.

FIG. 2 shows an example of a computer system configuration according to embodiment 1.

FIG. 3 shows an example of data stored in a memory 302 of an application server 300.

FIG. 4 shows an example of data stored in a memory 365 of a storage system 360.

FIG. 5 shows an example of a configuration of a flash memory device 367 with compression function in the storage system 360.

FIG. 6 shows an example of an object location information 403.

FIG. 7 shows an example of a cache control information 405.

FIG. 8 shows an example of a RAID group information 502.

FIG. 9 shows an example of a logical volume information 503.

FIG. 10 shows an example of a pool information 504.

FIG. 11 shows an example of a virtual volume information 505.

FIG. 12 shows an example of a tier definition information 506.

FIG. 13 shows an example of an object compression policy information 406.

FIG. 14 shows an example of an object compression policy information input screen 407.

FIG. 15 shows an example of a flash memory control information 606.

FIG. 16 shows an example of a read request 1700.

FIG. 17 shows an example of a read response 1800.

FIG. 18 shows an example of a read response data 1900.

FIG. 19 shows an example of a write request 2000.

FIG. 20 shows an example of the association between virtual volume, logical volume, RAID group, logical area within the flash memory device 367 with a compression function, and physical area within flash memory device 367 with a compression function.

FIG. 21 shows an example of the flow of processing when the database program 402 performs read processing.

FIG. 22 shows an example of the flow of processing when the database program 402 performs read processing.

FIG. 23 shows an example of the flow of processing when the database program 402 performs write processing.

FIG. 24 shows an example of the flow of processing within the storage system 360 when the application server 300 reads data from the storage system 360 or writes data thereto.

FIG. 25 shows an example of the flow of processing when the storage controller 363 moves a page having a large amount of access to a higher tier and moves a page having a small amount of access to a lower tier.

FIG. 26 shows an example of the flow of processing performed within the flash memory device with a compression function 367 when the storage controller 363 transmits a read request 1700 to the flash memory device with a compression function 367.

FIG. 27 shows an example of the flow of processing performed within the flash memory device with a compression function 367 when the storage controller 363 transmits a write request 2000 to the flash memory device with a compression function 367.

FIG. 28 is a view showing an outline of embodiment 2.

FIG. 29 shows an example of a GET LBA STATUS request 3000.

FIG. 30 shows an example of a GET LBA STATUS response 3100.

FIG. 31 shows an example of a GET LBA STATUS response data 3200.

FIG. 32 shows an example of the flow of processing when a cache control program 404 reads data from the storage system 360.

FIG. 33 shows an example of the flow of processing when the storage controller 363 reads data from the flash memory device 367 with a compression function.

FIG. 34 shows an example of the configuration of a computer system according to embodiment 3.

FIG. 35 shows an example of a cache control information 3506.

FIG. 36 shows an example of a snapshot volume control information 3512.

FIG. 37 shows an example of a flow of processing when a VM 3502 reads data.

### DESCRIPTION OF EMBODIMENTS

Now, the preferred embodiments of the present invention will be described with reference to the drawings. It should be noted that the present invention is not restricted to the embodiments described below.

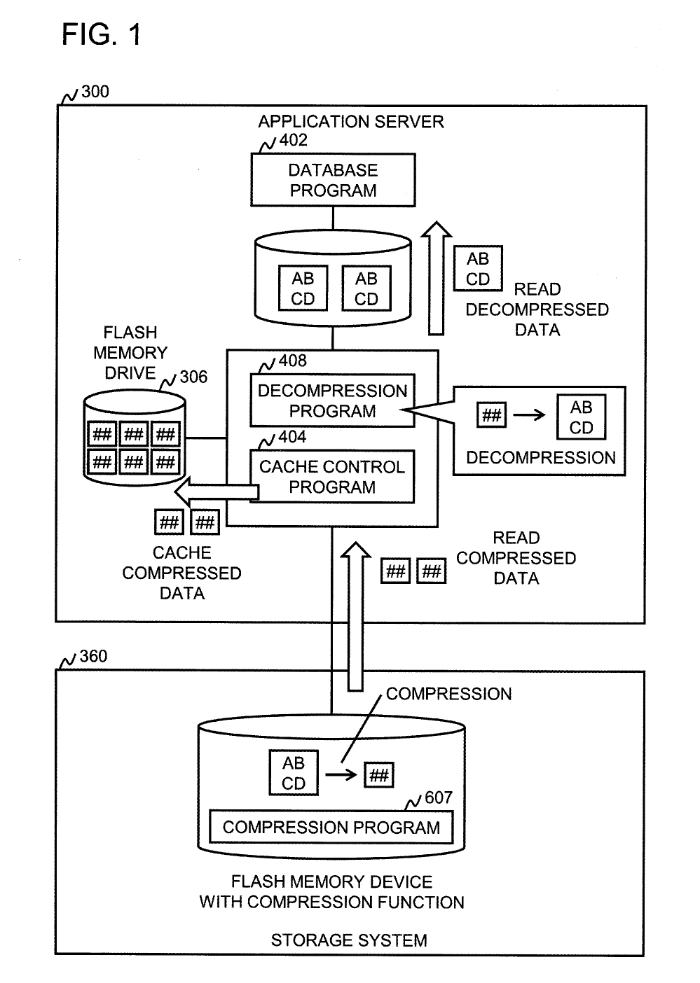

The outline of the present invention (FIG. 1) is as described below. The present system is a computer system having an application server 300 in which a database program 402 and a cache control program 404 are operated, and a storage system 360 having a compression function 607, which are connected via a communication network. A read request from the database program 402 is received by the cache control program 404, which determines whether the read target data is cached or not.

If the data is not cached, the data compressed by the storage system 360 is read by the cache control program 404, and the data read by the cache control program 404 is decompressed and transmitted to the database program 402. The compressed data is cached by the cache control program 404 to a flash memory drive 306, and when the read target data is cached, the compressed cache data is read from the flash memory drive 306, decompressed, and transmitted to the database program 402.

### Example 1

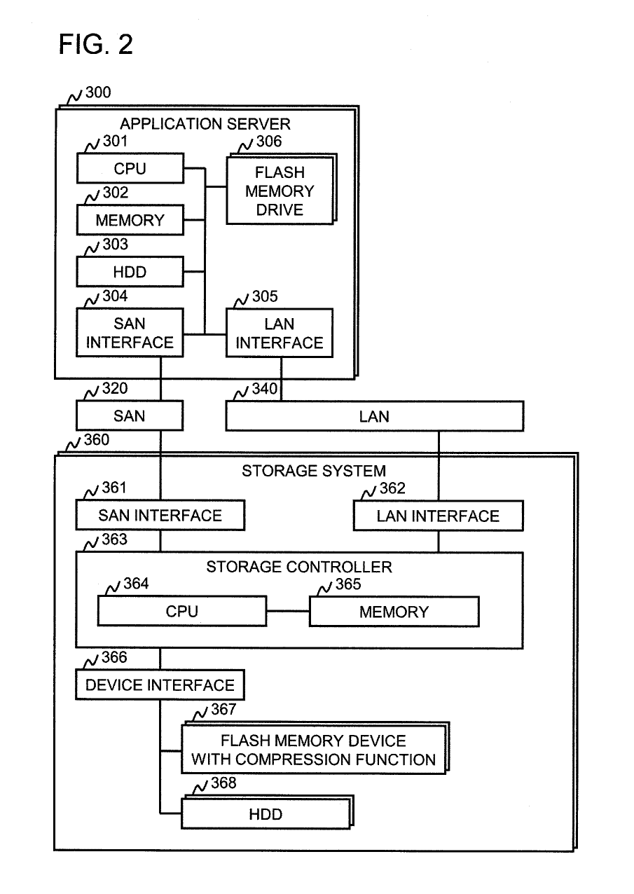

FIG. 2 illustrates a configuration of the computer system according to embodiment 1. The present computer system is equipped with an application server 300, a SAN (Storage Area Network) 320, a LAN (Local Area Network) 340, and a storage system 360. A CPU 301 loads to a memory 302 the program and data stored in an HDD 303 when the application server 300 is started, and executes the program.

The memory 302 stores the program to be executed by the CPU 301 and data of written to or read from the program. The HDD 303 stores the program and data read by the CPU 301 when the application server 300 is started. A SAN interface 304 is an interface connecting the application server 300 and the SAN 320. A LAN interface 305 is an interface connecting the application server 300 and the LAN 340. A flash memory drive 306 is used for caching the data read from or written into the storage system 360.

The SAN 320 is a network connecting the application server 300 and the storage system 360. The application on the application server 300 sends a read request and a write request via a SAN 320 to the storage system 360, and receives a response. The LAN 340 is a management network connecting the application server 300 and the storage system 360.

The LAN 340 is used for data communication for management purposes. The storage system 360 is equipped with a SAN interface 361, a LAN interface 362, a storage controller 363, a device interface 366, a flash memory device 367 with a compression function, and an HDD 368. The SAN interface 361 is an interface connecting the storage system 360 and the SAN 320.

The LAN interface 362 is an interface connecting the storage system 360 and the LAN 340. A storage controller 363 is equipped with a CPU 364 and a memory 365. The storage controller 363 is equipped with a function to receive a read request and a write request from an application 300, transmit the read request and the write request to the flash memory device 367 with a compression function and the HDD 368, and perform control thereof. The CPU 364 executes the program stored in the memory 365.

The memory 365 stores the program to be executed by the CPU 364 and data. A device interface 366 is an interface connecting the storage controller 363, the flash memory device 367 with a compression function and the HDD 368. The flash memory device 367 with a compression function is a flash memory device having a function to compress and decompress data.

When data is written into the flash memory device 367 with a compression function, the flash memory device 367 with a compression function has a function to compress the data written therein. When data is read, the flash memory device 367 with a compression function decompresses the compressed data. The flash memory device 367 with a compression function also has a function to read the compressed data stored in the flash memory device without decompressing the same. The HDD 368 is a device for retaining data. The storage controller 363 reads and writes data with respect to the flash memory device 367 with a compression function and the HDD 368.

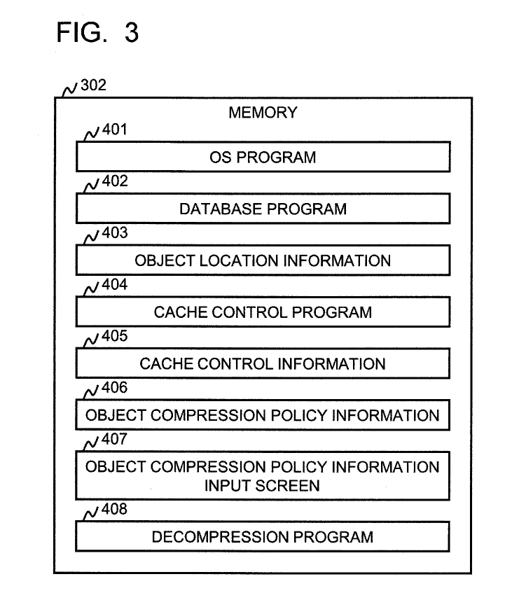

FIG. 3 shows the data stored in the memory 302 in the application server 300. An OS program 401 is a program for executing the database program 402. The database program 402 is one example of an application for reading data from the storage system 360, executing computation, and writing the computed result to the storage system 360.

An object location information 403 is information for managing the location of the information stored in the database program 402. A cache control program 404 is a program for caching the data read from or written to the storage system 360 by the application server 300 to the flash memory drive 306, and when the application server 300 reads data from the same area again, the data is read from the flash memory drive 306 and not read from the storage system 360.

A cache control information 405 is the information on the data cached in the flash memory drive 306. The cache control program 404 manages the cache control information 405. An object compression policy information 406 is information for performing setting on whether the data should be cached in the compressed state when being cached to the flash memory drive 306 for each object type. An object compression policy information input screen 407 is a screen that is used by the administrator to enter the object compression policy information 406. A decompression program 408 is a program for decompressing the compressed data.

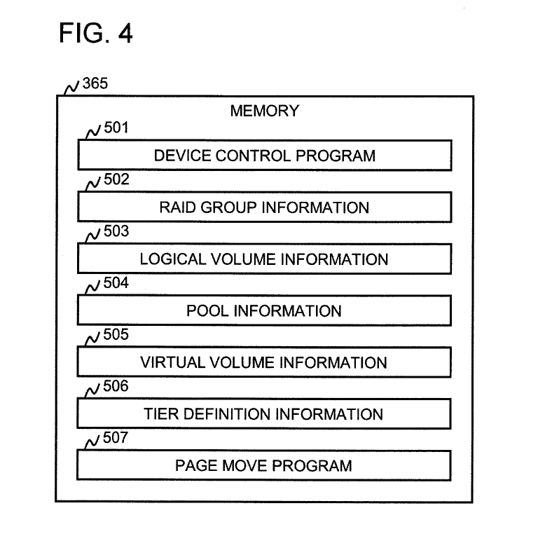

FIG. 4 shows the data stored in the memory 365 of the storage system 360. A device control program 501 is a program for sending a read request and a write request to the flash memory device 367 with a compression function and the HDD 368 based on the read request and the write request from the application server 300, and performing control thereof. A RAID (Redundant Arrays of Inexpensive Disks or Redundant Arrays of Independent Disks) group information 502 is an information for managing the RAID group configuration formed of the flash memory device 367 with a compression function and the HDD 368.

A logical volume information 503 is information for associating a logical volume with a RAID group. A pool information 504 is information for associating a pool with a logical volume. A virtual volume information 505 is information for associating a virtual volume with a logical volume. A tier definition information 506 is information for associating a tier with a medium. A page move program 507 moves the data stored in the flash memory device 367 with a compression function to the HDD 368, and moves the data stored in the HDD 368 to the flash memory device 367 with a compression function.

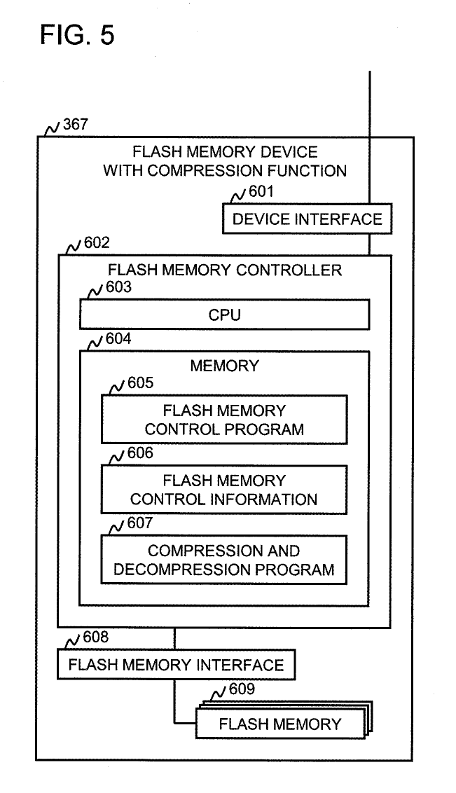

FIG. 5 shows the configuration of the flash memory device 367 with a compression function in the storage system 360. The device interface 601 is an interface for connecting the flash memory device 367 with a compression function and the storage controller 363. A flash memory controller 602 receives a read request and a write request from the storage controller 363, and reads data from or writes data to the flash memory 609. The flash memory controller 602 is equipped with a CPU 603 and a memory 604.

The CPU 603 executes programs stored in the memory 604. The memory 604 stores the programs executed by the CPU 603 and data. The memory 604 includes a flash memory control program 605, a flash memory control information 606, and a compression and decompression program 607. The flash memory control program 605 reads data from and writes data to the flash memory 609 in response to the read request or the write request from the storage controller 363, and manages the flash memory control information 606.

The flash memory control information 606 is information for associating the logical address visible from outside the flash memory device 367 with a compression function with the physical address in the flash memory 609. A flash memory interface 608 is an interface connecting the flash memory controller 602 and the flash memory 609. The flash memory 609 is a nonvolatile memory for retaining data.

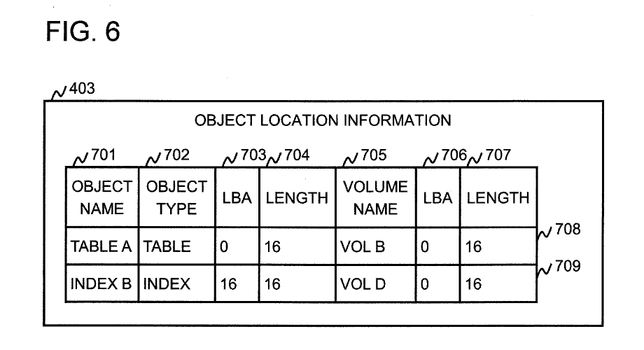

FIG. 6 illustrates an object location information 403 stored in the memory 302 of the application server 300. The object location information 403 includes an object name 701, an object type 702, an LBA (Logical Block Address) 703, a length 704, a volume name 705, an LBA 706, and a length 707. It shows that the database program 402 has stored the object data specified by the object name 701, the LBA 703 and the length 704 in the area of the storage system 360 specified by the volume name 705, the LBA 706 and the length 707. When an object to be processed is newly created by the database program 402, when an object is deleted, and when the data capacity of the object is increasing, the database program 402 updates the object location information 403.

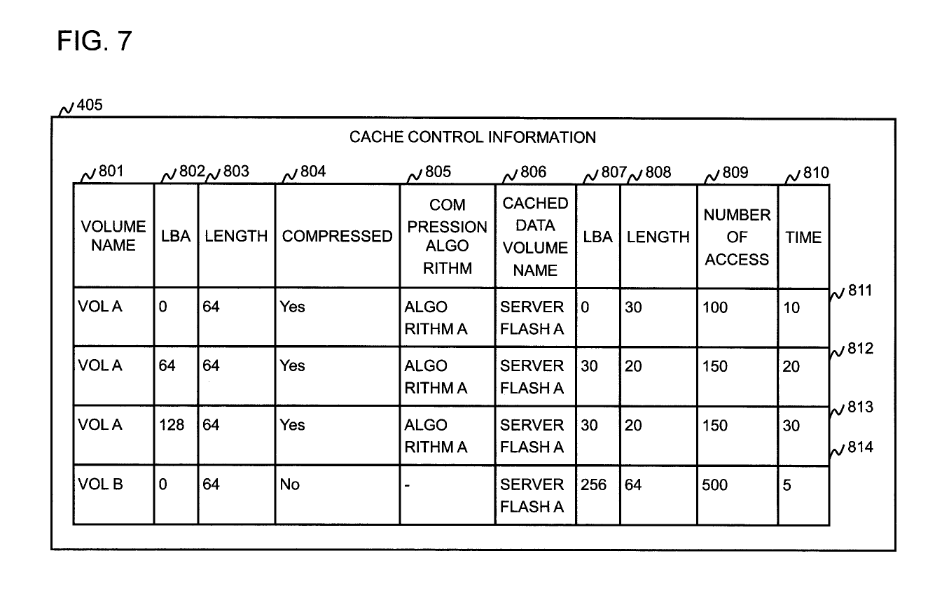

FIG. 7 shows a cache control information 405 stored in the memory 302 of the application server 300. The cache control information 405 includes a volume name 801, an LBA 802, a length 803, a compressed flag 804, a compression algorithm 805, a cached data volume name 806, an LBA 807, a length 808, a number of access 809, and a time 810.

The cache control program 404 shows that the area of the storage system 360 specified by the volume name 801, the LBA 802 and the length 803 is cached in the flash memory drive 306 specified by the cached data volume name 806, the LBA 807 and the length 808, and that the cached data is valid. If the compressed flag 804 is “Yes”, it means that the cached data is compressed by the algorithm designated in the compression algorithm 805. If the compressed flag 804 is “No”, it means that the cached data is not compressed. The number of access 809 shows the number of accesses to the cached data. The time 810 shows the time in which the cached data had last been accessed.

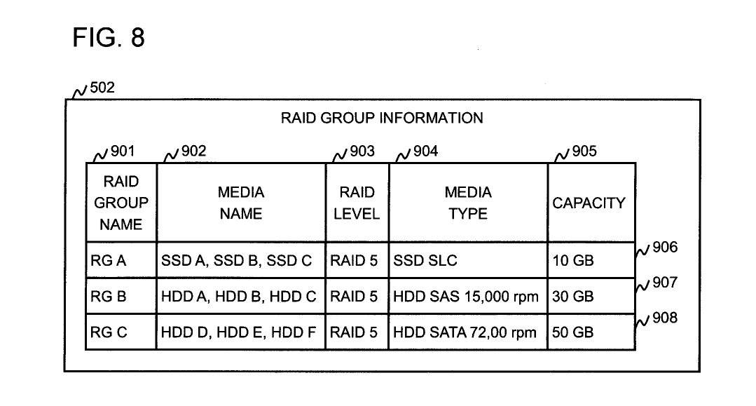

FIG. 8 shows a RAID group information 502 stored in the memory 365 of the storage system 360. The RAID group information 502 includes a RAID group name 901, a media name 902, a RAID level 903, a media type 904 and a capacity 905. The RAID group name 901 shows the name of the RAID group. The media name 902 shows the media constituting the RAID group. The RAID level 903 shows the RAID level. The media type 904 shows the type of the media constituting the RAID group. The capacity 905 shows the capacity of the RAID group.

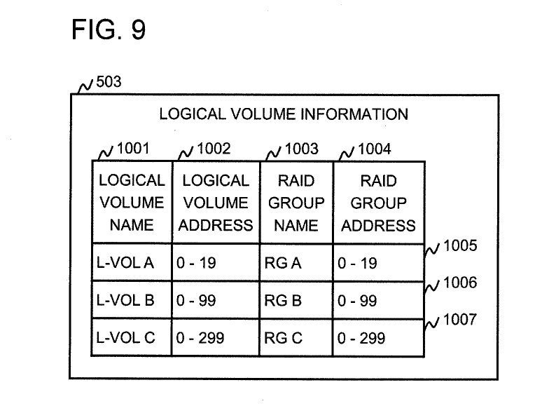

FIG. 9 shows a logical volume information 503 stored in the memory 365 of the storage system 360. The logical volume information 503 includes a logical volume name 1001, a logical volume address 1002, a RAID group name 1003, and a RAID group address 1004. It shows that the area specified by the logical volume name 1001 and the logical volume address 1002 corresponds to the area specified by the RAID group name 1003 and the RAID group address 1004.

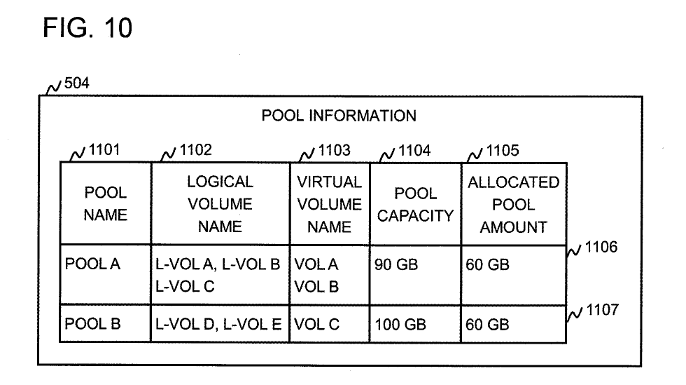

FIG. 10 shows a pool information 504 stored in the memory 365 of the storage system 360. The pool information 504 includes a pool name 1101, a logical volume name 1102, a virtual volume name 1103, a pool capacity 1104 and an allocated pool amount 1105. The pool name 1101 refers to the name of the pool. The logical volume name 1102 refers to the logical volume name belonging to the pool. The virtual volume name 1103 refers to the name of the virtual volume belonging to the pool. The pool capacity 1104 refers to the capacity of the pool. The allocated pool amount 1105 refers to the capacity already allocated to the virtual volume out of the pool capacity.

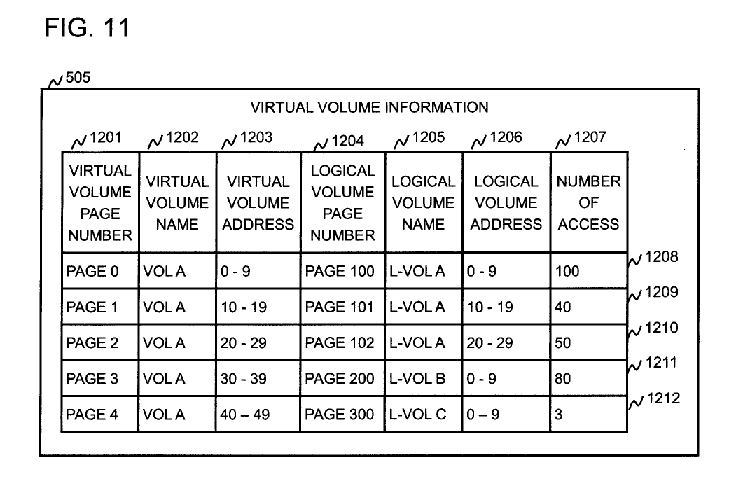

FIG. 11 shows a virtual volume information 505 stored in the memory 365 of the storage system 360. The virtual volume information 505 includes a virtual volume page number 1201, a virtual volume name 1202, a virtual volume address 1203, a logical volume page number 1204, a logical volume name 1205, a logical volume address 1206 and a number of access 1207.

The virtual volume page number 1201 refers to a page number of the area specified by the virtual volume name 1202 and the virtual volume address 1203. The logical volume page number 1204 refers to a page number of the area specified by the logical volume name 1205 and the logical volume address 1206. It shows that the area specified by the virtual volume page number 1201 corresponds to the area specified by the logical volume page number 1204. The number of access 1207 refers to the number of accesses to the area specified by the virtual volume page number 1201.

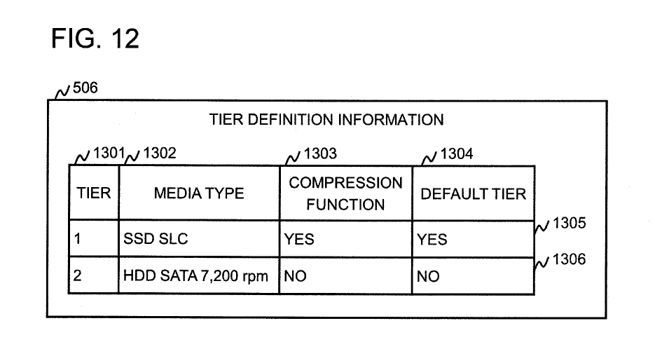

FIG. 12 shows a tier definition information 506 stored in a memory 365 of the storage system 360. The tier definition information 506 comprises a tier 1301, a media type 1302, a compression function 1303 and a default tier 1304. The tier 1301 refers to the tier. The tier is shown by numerals, wherein smaller numbers represent higher performances of the media. According to the present embodiment, the tiers are composed of two levels, tier 1 and tier 2, but the tiers can also be composed of 3 or more tiers. The media type 1302 refers to the type of the media constituting the tiers.

The compression function 1303 is set to “Yes” if the media is equipped with the compression function, and set to “No” if the media is not equipped with the compression function. The default tier 1304 shows the page to be allocated when a write request is received to an unallocated area. If the page is to be allocated to an unallocated area, “Yes” is entered, and if the page is not to be allocated to an unallocated area, “No” is entered. However, if data is written into an unallocated area when pages set to “Yes” are all allocated to the default tier 1304, a page set to “No” in the default tier 1304 is allocated.

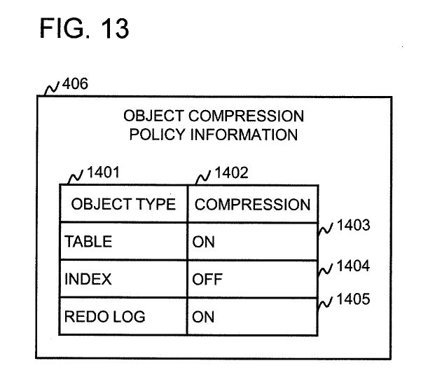

FIG. 13 shows an object compression policy information 406 stored in the memory 302 of the application server 300. The object compression policy information 406 includes an object type 1401 and a compression flag 1402. The compression flag 1402 indicates whether the object indicated in the object type 1401 is to be cached as it is in the compressed state when being cached to the flash memory drive 306 of the application server 300. If the compression flag 1402 is set to “Yes”, the object shown in the object type 1401 is cached in the compressed state, and if the compression flag 1402 is set to “No”, the object shown in the object type 1401 is decompressed before being cached.

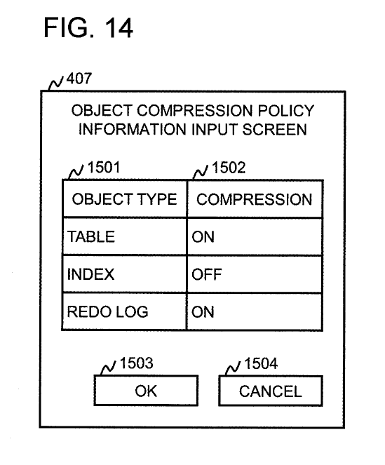

FIG. 14 shows an object compression policy information input screen 407 stored in the memory 302 of the application server 300. The object compression policy information input screen 407 includes an object type 1501, a compression 1502, an OK button 1503, and a cancel button 1504. The data is shown on a display of the application server 300.

When caching the object shown in the object type 1501 to the flash memory drive 306 of the application server 300, the administrator enters “Yes” in the compression 1502 if he/she wishes to cache the object in the compressed state, and enters “No” in the compression 1502 if he/she wishes to cache the object after it is decompressed, before clicking the OK button 1503. Thus, the information entered in an object compression policy information input screen 407 by the administrator is reflected in the object compression policy information 406. If the administrator wishes not to change the settings, he/she clicks the cancel button 1504.

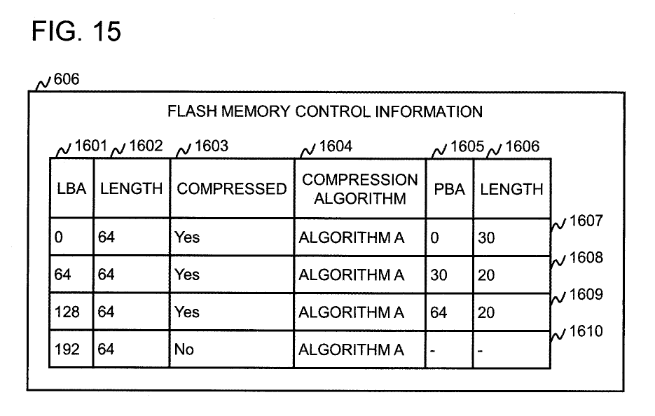

FIG. 15 shows a flash memory control information 606 stored in the memory 604 of the flash memory device 367 with a compression function. The flash memory control information 606 includes an LBA 1601, a length 1602, a compressed flag 1603, a compression algorithm 1604, a PBA (Physical Block Address) 1605 and a length 1606.

The LBA 1601 shows the address visible to the exterior of the flash memory device 367 with a compression function. The PBA 1605 is a physical address stored in the flash memory 609. It is shown that the flash memory controller 602 stores the area specified by the LBA 1601 and the length 1602 in the area specified by the PBA 1605 and the length 1606, and that it is effective. If “Yes” is entered in the compressed flag 1603, it means that the data is compressed by the algorithm designated in the compression algorithm 1604. If “No” is entered in the compressed flag 1603, it means that the data is not compressed.

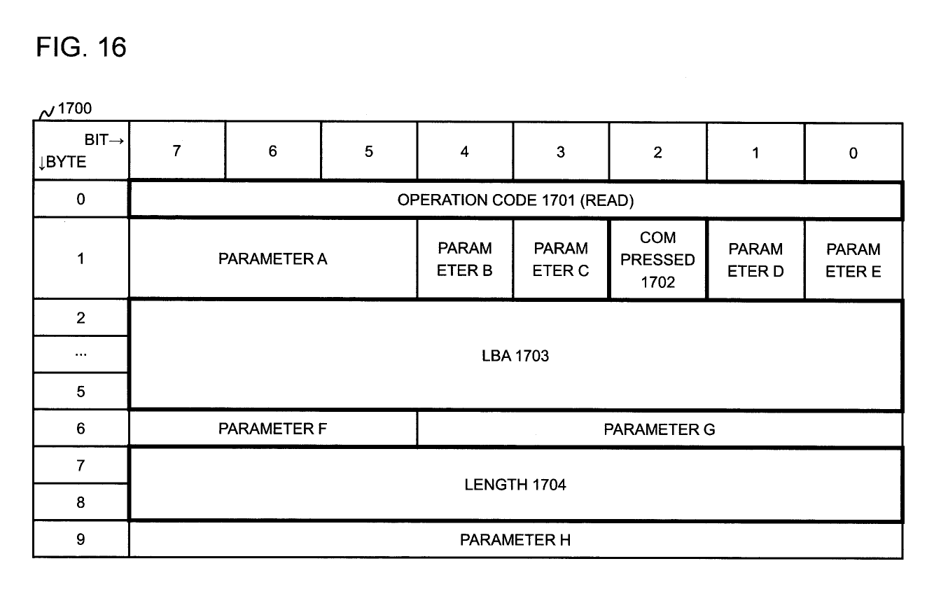

FIG. 16 illustrates a read request 1700. The read request 1700 includes an operation code 1701, a compression flag 1702, an LBA 1703 and a length 1704. The operation code 1701 indicates that the present request is a read request. The compression flag 1702 is a flag indicating whether the compressed data should be read as it is in the compressed state or not.

When “1” is entered in the compression flag 1702, it means that compressed data can be read if possible, and the device having received the read request 1700 returns a read response 1800. When “0” is entered in the compression flag 1702, it means that the request is a normal read request and uncompressed data will be read, the device having transmitted the read request 1700 ensures an area having a size designated by the length 1704, and the device having received the read request 1700 transmits the read data.

The LBA 1703 shows the beginning address of the data to be read. The length 1704 shows the length of the data to be read. If the device having transmitted the read request 1700 intends to read the data in a state where the area designated by the LBA 1703 and the length 1704 is not compressed, “0” is entered in the compression flag 1702, and if the device intends to read the data in a state where the area is compressed, “1” is entered in the compression flag 1702. However, even when “1” is set in the compression flag 1702, if the area being designated by the LBA 1703 and the length 1704 is not compressed within the read target device, the data is read in a non-compressed state.

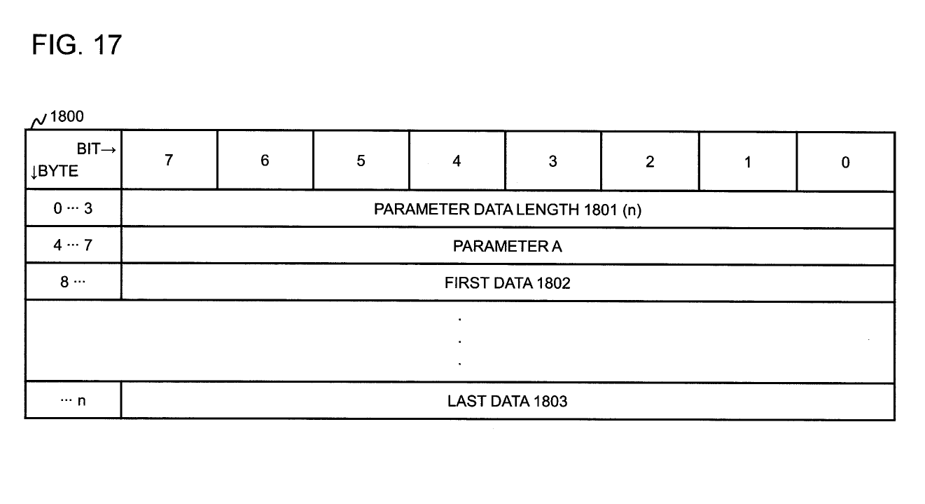

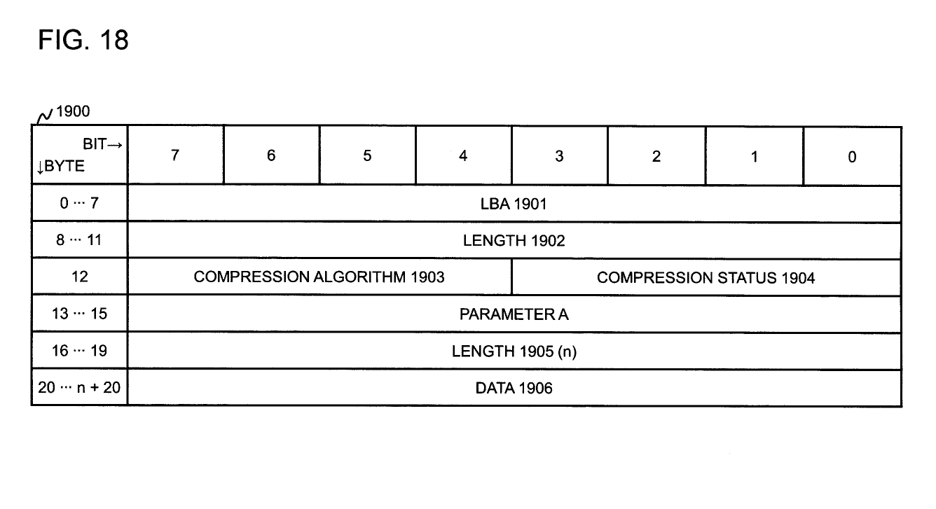

FIG. 17 shows a read response 1800. The read response 1800 illustrates the response to a read request 1700. The read response 1800 includes a parameter data length 1801 and arbitrary number of data 1802 and 1803. The parameter data length 1801 shows a sum of a read response header and a read response data. Since the data in the area of the storage system 360 designated by the LBA 1703 and the length 1704 may be divided and compressed, the read data will be in a list format, as shown in FIG. 18.

FIG. 18 shows a read response data 1900. The read response data 1900 is a portion of the read response 1800, corresponding to data 1802 and 1803. The read response data 1900 includes an LBA 1901, a length 1902, a compression algorithm 1903, a compression status 1904, a data length 1905, and data 1906. The LBA 1901 shows a beginning address of the read destination. The length 1902 shows the length of the data to be read. The compression algorithm 1903 shows the compression algorithm when data is being compressed. The compression status 1904 shows whether the data 1906 is compressed or not.

When “1” is entered in the compression status 1904, it means that the data 1906 is compressed. When “0” is entered in the compression status 1904, it means that the data 1906 is not compressed. The data length 1905 shows the length of the data 1906. The data 1906 refers to the data of the area in the storage system 360 designated by the LBA 1901 and length 1902.

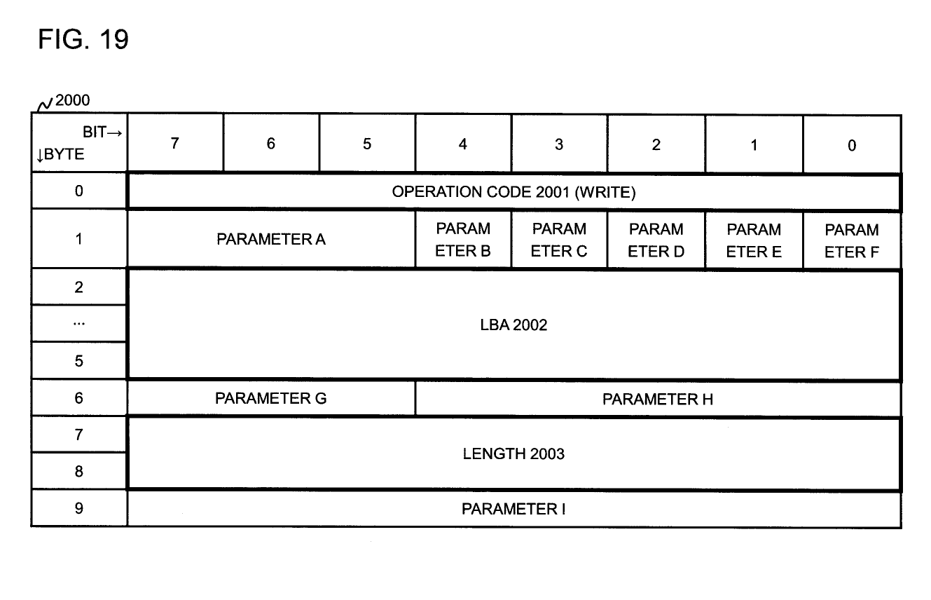

FIG. 19 shows a write request 2000. The write request 2000 includes an operation code 2001, an LBA 2002 and a length 2003. The operation code 2001 indicates that the present request is a write request. The LBA 2002 shows a beginning address for writing data. The length 2003 indicates the length of the data to be written. The device having received the write request 2000 allocates an area having a size designated by the length 2003, and the device having transmitted the write request 2000 transmits data to that area.

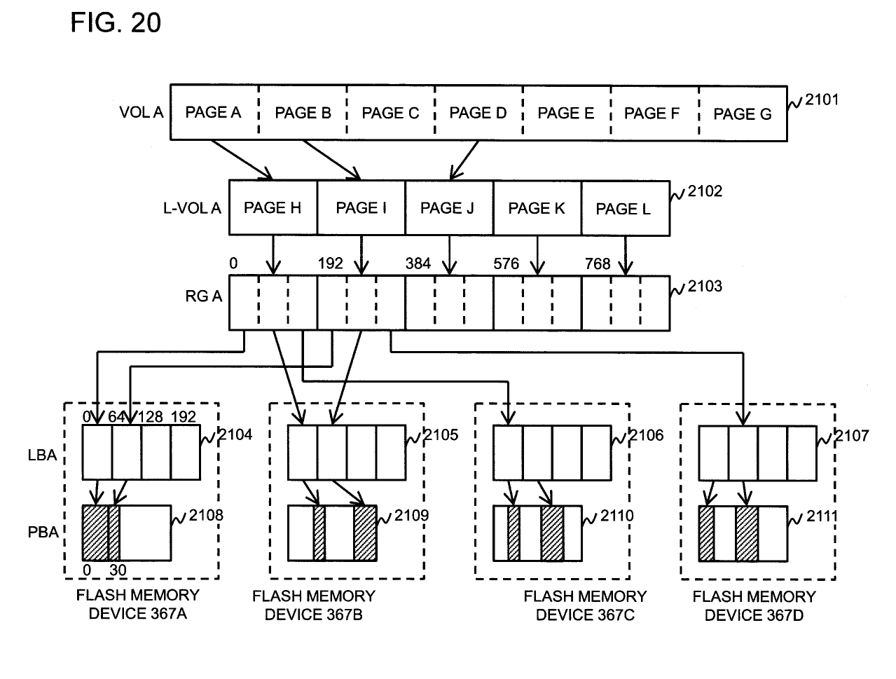

FIG. 20 illustrates the association between a virtual volume, a logical volume, a RAID group, a logical area within the flash memory device 367 with a compression function, and a physical area within the flash memory device 367 with a compression function. When the database program 402 transmits a read request and a write request, data is read and/or written based on the relationship illustrated in FIG. 20. The virtual volume information 505 shows the association between the addresses of VOL A 2101 and L-VOL A 2102. The logical volume information 503 shows the association between the L-VOL A 2102 and the RG A 2103. The RAID group information 502 shows the association between the RG A 2103 and the LBA 2104 of the flash memory device 367 with a compression function. The flash memory control information 606 shows the association between the LBA 2104 within the flash memory device 367 with a compression function and the PBA 2108.

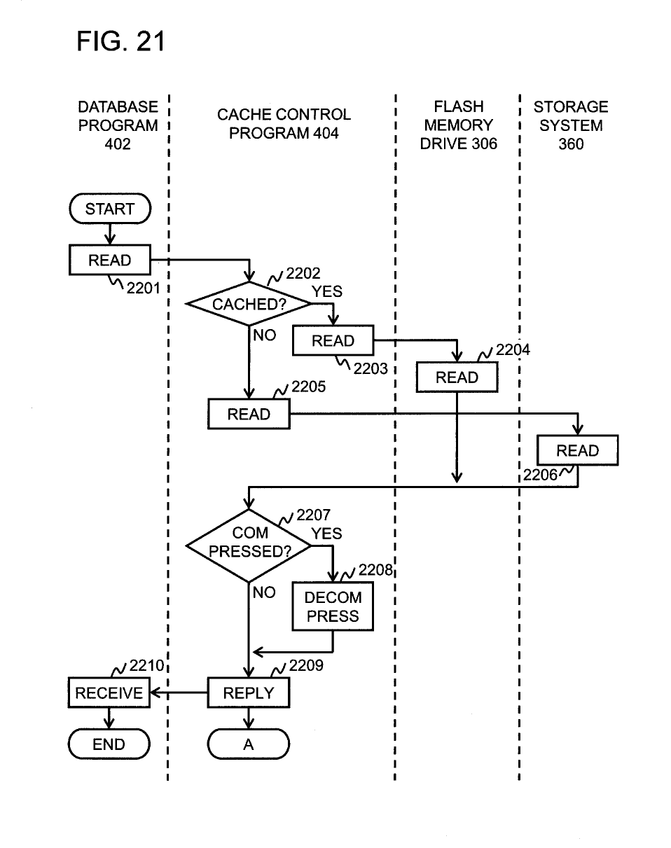

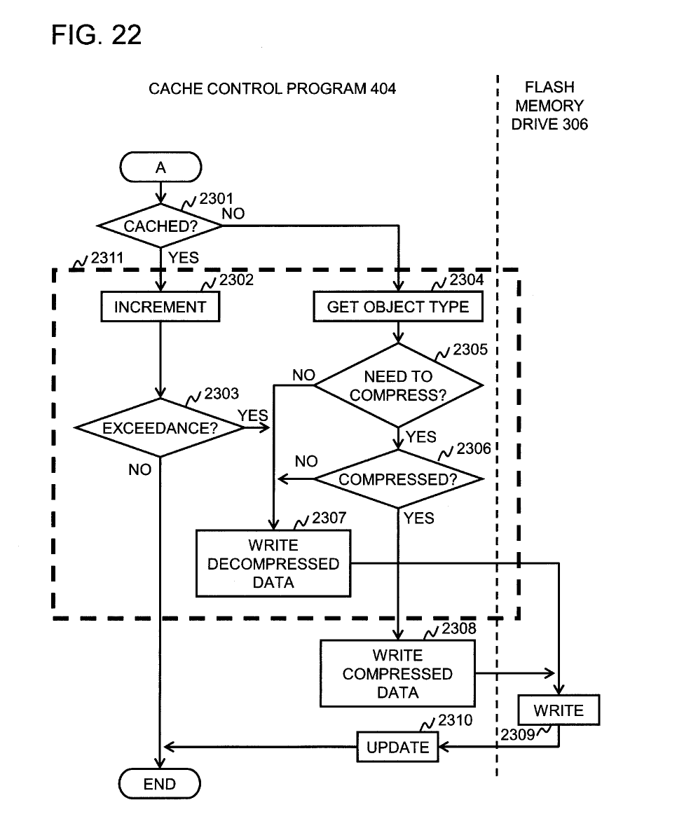

FIGS. 21 and 22 illustrate a process flow when the database program 402 performs a read process. In step 2201, the database program 402 transmits a read request 1700 to the cache control program 404. The OS program 401 and the database program 402 has an area for caching the read data in the memory 302, wherein the present process is a process to be performed when data is not cached thereto. A read destination area is designated in the LBA 1703 and the length 1704. The database program 402 does not have a function to decompress the compressed data, and since it is necessary to read decompressed data, “0” is entered in the compression flag 1702.

In decision 2202, the cache control program 404 confirms by referring to the cache control information 405 whether the read destination area designated by the read request 1700 received in step 2201 is cached in the flash memory drive 306 or not, wherein if it is cached, the process advances to step 2203, and if it is not cached, the process advances to step 2205.

In step 2203, the cache control program 404 specifies the cache destination area by referring to the cached data volume name 806, the LBA 807 and the length 808 in the cache control information 405, wherein the area is designated in the LBA 1703 and the length 1704, and “1” is entered in the compression flag 1702, therefore the read request 1700 is transmitted to the flash memory drive 306. This process is performed to read the data from the storage system side in the compressed state in the following processes.

In step 2204, the flash memory drive 306 reads the data in the area designated in the read request 1700. In step 2205, the cache control program 404 designates the read destination area in the LBA 1703 and the length 1704, enters “1” in the compression flag 1702, and transmits the read request 1700 to the storage system 360. In step 2206, data is read without performing decompression.

In decision 2207, if the data read by the cache control program 404 in step 2203 or step 2205 is compressed, the procedure advances to step 2208. If not, the procedure advances to step 2209.

In step 2208, the cache control program 404 refers to the cache control information 405, wherein if the compressed flag 804 is set to “Yes”, the read data is decompressed based on the decompression algorithm corresponding to the compression algorithm designated in the compression algorithm 805. After the program confirms that data is not cached by referring to the cache control information 405, if the compression status 1904 of the read response data received from the storage system 360 is “1”, the read data is decompressed based on the decompression algorithm corresponding to the algorithm designated by the compression algorithm 1903.

In step 2209, the cache control program 404 transmits the read data to the database program 402, and proceeds to step 2210 and step 2301. In step 2210, the database program 402 receives a read result.

In decision 2301, if the read target has been cached according to decision 2202, the process is ended, and if it is not cached, the procedure advances to step 2308. In step 2308, the cache control program 404 caches the compressed data to the flash memory drive 306. Similar to step 2307, a free space is searched, and data is written into the free space. In step 2309, the flash memory drive 306 writes in data.

In step 2310, the cache control program 404 updates the cache control information 405. The flow of the process when the database program 402 reads data is as described, but if the performance should be enhanced even further, it is possible to execute the steps and decisions surrounded by the dotted line 2311.

Now, we will describe the case where the process and the decision surrounded by the dotted line 2311 is executed. In decision 2301, if the read target has been cached according to decision 2202, the procedure advances to step 2302, and if the data has not been cached, the procedure advances to step 2304.

In step 2302, the cache control program 404 increments the number of access 809 of the cached data. In decision 2303, the cache control program 404 determines whether the number of access 809 has exceeded a threshold set in advance or not. If the number has exceeded the threshold, the procedure is advanced to step 2307 to decompress and cache the compressed and cached data. If not, the process is ended.

In step 2304, the cache control program 404 acquires the object type 702 of the data read from the object location information 403 acquired from the database program 402. Further, the cache control program 404 periodically acquires the object location information 403 from the database program 402. In decision 2305, the cache control program 404 refers to the object compression policy information 406, and determines whether to perform cache to the read data in the compressed state. If the compression flag 1402 of the object type 702 acquired in step 2304 is “On”, the procedure advances to decision 2306, and if the compression flag 1402 is “Off”, the procedure advances to step 2307.

In decision 2306, it is determined whether the data that the cache control program 404 has read from the storage system 360 in decision 2207 has been compressed or not. If the read data has been compressed, the procedure advances to step 2308 to cache the compressed data. If the read data has not been compressed, since the cache control program 404 does not retain the compressed data and cannot cache the compressed data, the procedure advances to step 2307 to cache the non-compressed data.

In step 2307, the cache control program 404 caches the non-compressed data in the flash memory drive 306. The program refers to the cache control information 405, and searches for a free space. When there is no free space, a row in which the time 810 of the cache control information 405 is oldest is searched, and the row is deleted. The cache control program 404 writes data into the free space.

The above has described the flow of the process for executing the steps and decisions surrounded by the dotted line 2311. By providing the decision step of 2303, the load applied on the application server 300 can be reduced by not subjecting the data having a high access frequency to decompression processing. Further, whether to cache the data by compressing the data in object units or to cache the data in a decompressed state can be controlled based on an object compression policy 406 set by the administrator.

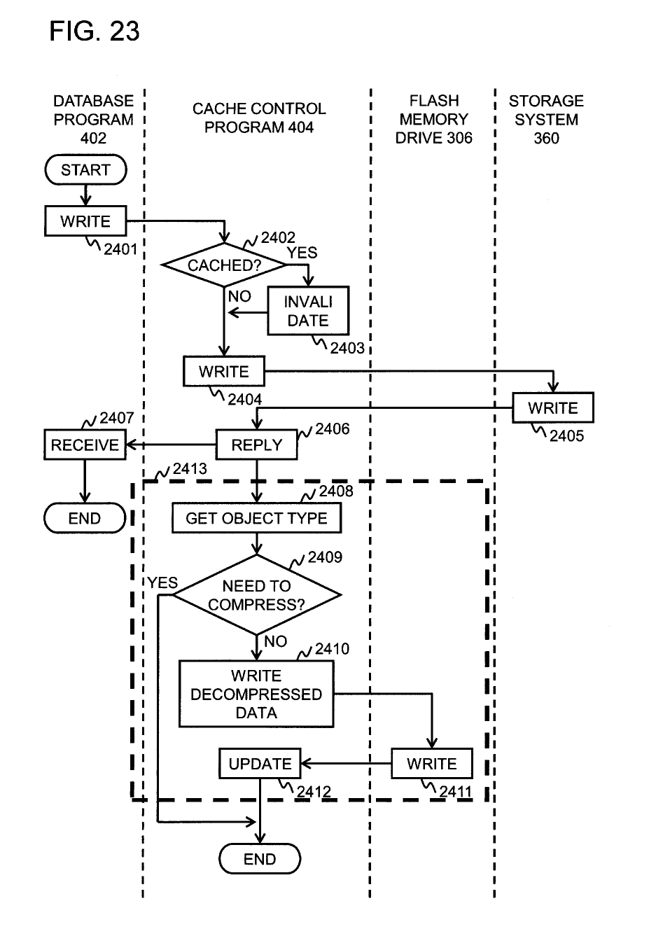

FIG. 23 shows a flow of the writing process performed by the database program 402. In step 2401, the database program 402 transmits a write request 2000 to the cache control program 404. In decision 2402, the cache control program 404 determines whether the write destination area designated by the write request 2000 received in step 2401 is cached in the flash memory drive 306 or not. The cache control program 404 refers to the cache control information 405 for confirmation, wherein if the data is cached, the procedure advances to step 2403, and if not, the procedure advances to 2404.

In step 2403, the cache control program 404 deletes the write destination area from the cache control information 405. In step 2404, the cache control program transmits a write request 2000 to the storage system 360. In step 2405, the storage system 360 writes in the data. In step 2406, the cache control program 404 responds to the database program 402 and advances to step 2407. In step 2407, the database program 402 receives the write results. The above describes the flow of the process for writing data by the database program 402.

In FIG. 22, the process surrounded by dotted line 2311 will be executed in order to control whether to compress the data in object units before caching the data or to decompress the same before caching the data, and the processes and decisions surrounded by dotted line 2413 are performed. The processes will be described below. In step 2406, the cache control program 404 responds the write result to the database program 402 before proceeding to step 2408.

In step 2408, the cache control program 404 acquires the object type 702 of the write data from the object location information 403 acquired from the database program 402. In decision 2409, the cache control program 404 refers to the object compression policy information 406, and determines whether to cache the write data without performing compression. Since the database program 402 does not have a data compression function, the write data from the database program 402 is not compressed, the cache control program 404 does not have a data compression function so that it cannot compress and cache the write data, so that if the compression flag 1402 of the object type 702 acquired in step 2408 is “On”, the process is ended. If the compression flag 1402 is “Off”, the procedure advances to step 2410.

In step 2410, the cache control program 404 caches the non-compressed data to the flash memory drive 306. It refers to the cache control information 405 and searches for free space. If there is no free space, the row in which the time 810 of the cache control information 405 is oldest is searched, and the row is deleted. The cache control program 404 writes data into the free space of the flash memory drive 306.

In step 2411, the flash memory drive 306 writes in data. In step 2412, the cache control program 404 updates the cache control information 405. The above description illustrates the process for executing the processes and decisions surrounded by the dotted line 2413. According to this process, when the database program 402 performs the writing process, if the write data is an object designated to be cached without compression based on the object compression policy 406, the data can be cached, and when there is need to read the same area as the data being written, it is only necessary to read the data cached in the flash memory drive 306, so that there is no need to read data from the storage system 360.

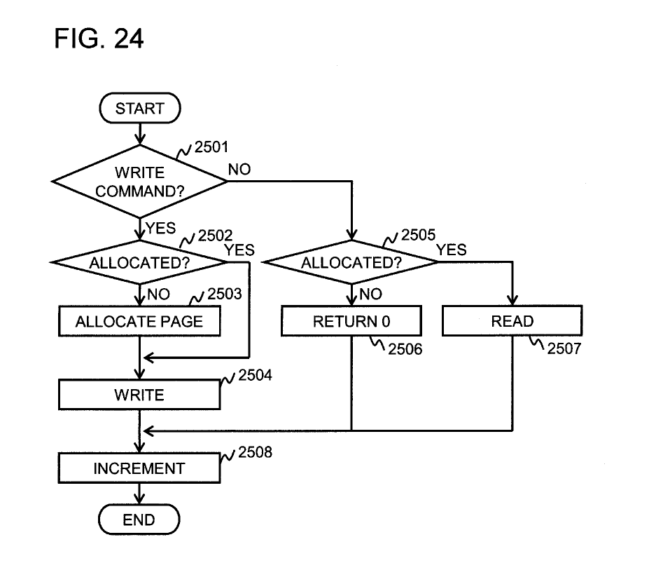

FIG. 24 shows the flow of the process within the storage system 360 when the application server 300 reads data from or writes data into the storage system 360. In decision 2501, when the application server 300 transmits a read request 1700, the procedure advances to step 2505, and if the application server 300 transmits a write request 2000, the procedure advances to decision 2502. In decision 2502, the storage controller 363 refers to the virtual volume information 505, wherein when a write destination area designated by the write request 2000 is not allocated, the procedure advances to step 2503, and if not, the procedure advances to step 2504.

In step 2503, the storage controller 363 refers to the pool information 504, allocates a page from the tier in which the default tier 1304 is set to “Yes” in the tier definition information 506 out of the logical volumes belonging to the same pool, and updates the virtual volume information 505. In step 2504, the storage controller 363 refers to the virtual volume information 505, and specifies the area in the logical volume corresponding to the area in the virtual volume specified by the LBA 2002 and the length 2003 of the write request 2000.

Next, the storage controller refers to the logical volume information 503 and specifies the area in the RAID group corresponding to the write target area in the logical volume. Further, the storage controller refers to the RAID group information 502 to specify the area in the device corresponding to the write target area in the RAID group, and transmits the write request 2000 to the flash memory device 367 with a compression function or the HDD 368. In decision 2505, if the target area of the read request 1700 transmitted from the application server 300 is unallocated, the procedure advances to step 2506, and if not, the procedure advances to step 2507.

In step 2506, the storage controller 363 determines that data is not written since the read destination area is unallocated, so that it returns 0 to the application server 300. In step 2507, the storage controller 363 refers to the virtual volume information 505, and specifies the area in the logical volume corresponding to the area in the virtual volume specified by the LBA 1703 and the length 1704 of the read request 1700.

Next, the storage controller refers to the logical volume information 503 and specifies the area in the RAID group corresponding to the read target area in the logical volume. Further, the storage controller refers to the RAID group information 502 to specify the area in the device corresponding to the read target area in the RAID group, and transmits the read request 1700 to the flash memory device 367 with a compression function or the HDD 368. If the compression flag 1702 of the read request 1700 from the application server 300 is “1” and the read target is the flash memory device 367 with a compression function, the compression flag 1702 is set to “1”. In step 2508, the number of access 1207 of the target page of access is incremented.

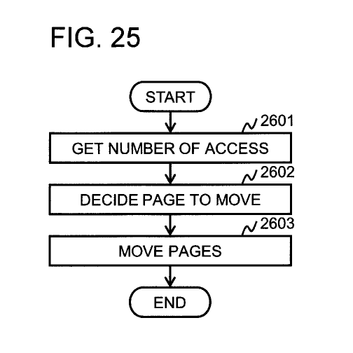

FIG. 25 illustrates the flow of the process in which the storage controller 363 moves the page having a large amount of accesses to a higher tier and moves the page having a small amount of accesses to a lower tier. The present process can be executed periodically via given intervals set by the administrator, such as once an hour or once every 24 hours. In step 2601, the storage controller 363 refers to the number of access 1207, and in step 2602, determines the page to be moved to a higher tier and the page to be moved to a lower tier. In step 2602, the determined page to be moved is moved in step 2603.

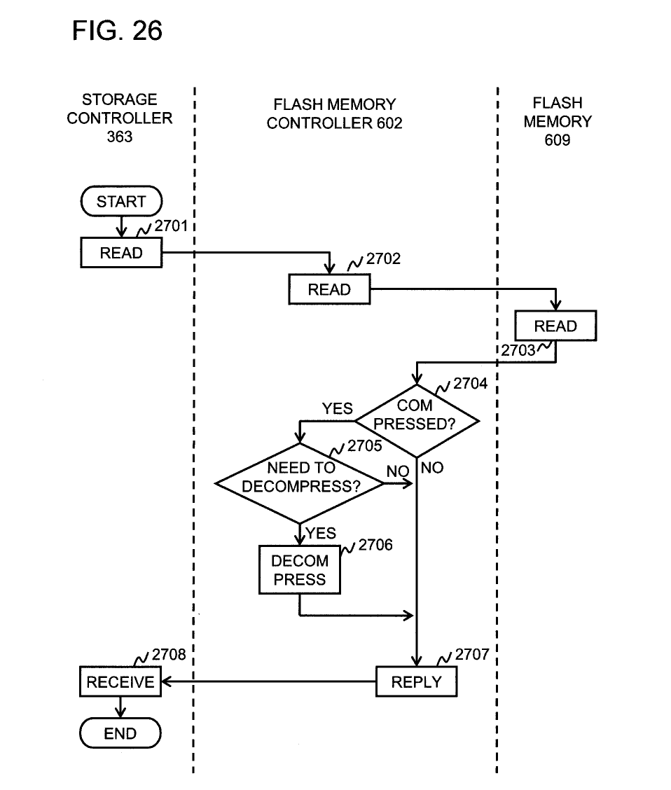

FIG. 26 shows in detail the process of step 2206 of FIG. 21 performed in the storage system 360, which shows the flow of the process within the flash memory device 367 with a compression function when the storage controller 363 transmits the read request 1700 to the flash memory device 367 with a compression function.

In step 2701, the storage controller 363 transmits the read request 1700 to the flash memory device 367 with a compression function. In step 2702, the flash memory controller 602 refers to the flash memory control information 606, and reads the read target area from the flash memory 609.

In step 2703, the flash memory 609 reads in data and transmits the data to the flash memory controller 602. In step 2707, the read data is transmitted to the storage controller 363. In step 2708, the storage controller 363 receives the read data.

Furthermore, it is possible to add the processes of steps 2704 to 2706 as additional embodiment. In decision 2704, the flash memory control information 606 is referred to in order to determine whether the read data is compressed or not. If it is compressed, the procedure advances to decision 2705, and if not, the procedure advances to step 2707. In decision 2705, it is determined whether the data decompressed and read into the storage controller 363 must be returned.

There are cases where data should be transmitted to the read request transmission source after decompressing the data, such as when a backup server not having a decompression function must read data for backup. Therefore, in step 2701, if the compression flag 1702 of the read request 1700 transmitted from the storage controller 363 is “1”, the procedure advances to step 2707, and if not, the procedure advances to step 2706. In step 2706, the flash memory controller 602 decompresses the read data using a decompression algorithm corresponding to the compression algorithm 1604.

Further, it is possible to execute decision 2704, decision 2705 and step 2706 of the added embodiment by the storage controller 363 instead of the flash memory controller 602 after step 2708.

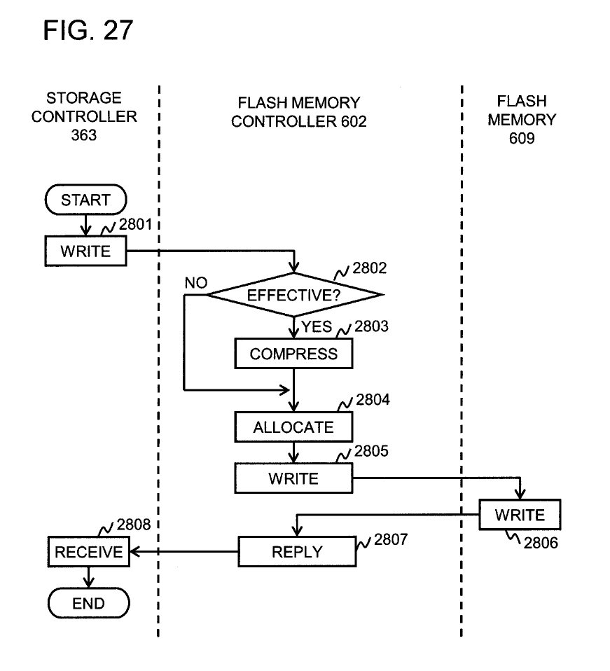

FIG. 27 illustrates the process within the flash memory device 367 with a compression function when the storage controller 363 transmits a write request 2000 to the flash memory device 367 with a compression function. In step 2801, the storage controller 363 transmits a write request 2000 to the flash memory device 367 with a compression function. In decision 2802, the flash memory controller 602 determines whether the data length could be shortened by compressing the write data. If it is determined that the data length can be shortened, the procedure advances to step 2803, and if not, the procedure advances to step 2804. In step 2803, the flash memory controller 602 compresses the data.

In step 2804, the flash memory control information 606 is referred to in order to allocate the address of the flash memory 609 as data write destination, and a free space is searched. The LBA 1601 and the length 1602 which is the area visible from the storage controller 363 is associated with the PBA 1605 and the length 1606 of the area of the write destination flash memory 609, wherein if it is determined that the data should be compressed in decision 2802, the compressed flag 1603 is set to “Yes”, the compression algorithm used in step 2803 is designated as the compression algorithm 1604, and the flash memory control information 606 is updated.

In step 2805, the flash memory controller 602 writes data into the flash memory 609. In step 2806, the flash memory 609 writes data. In step 2807, the flash memory controller 602 transmits the write result to the storage controller 363. In step 2808, the storage controller 363 receives the write result.

In embodiment 1, the data is compressed via the flash memory device 367 with a compression function, but the data can also be compressed via the storage controller 363. In that case, prior to performing step 2801 by the storage controller 363, the storage controller 363 executes decision 2802 and step 2803.

According to embodiment 1, the cache control program 404 performs reading and caching without the flash memory device 367 with a compression function decompressing the compressed data, so that a large amount of data can be cached to the flash memory drive 306 without applying the load of compression processing to the server.

Further, the object that the administrator determines as having a high access frequency and the area having a high access frequency are decompressed before being cached, so as to omit the decompressing process that occurs per access, according to which both the capacity efficiency and performance can be improved. Furthermore, since the data is transmitted as it is in the compressed state from the storage system 360 to the application server 300, the load applied on the SAN 320 can be reduced.

### Embodiment 2

Now, we will describe embodiment 2. According to embodiment 1, when the cache control program 404 reads data from the storage system 360, it was possible to select whether to read the data in the compressed state or read the data after decompression by setting the compression flag 1702. Embodiment 2 illustrates another method for reading the compressed data and decompressed data. Since the processes other than the read processing are the same as embodiment 1, only the read processing will be described here.

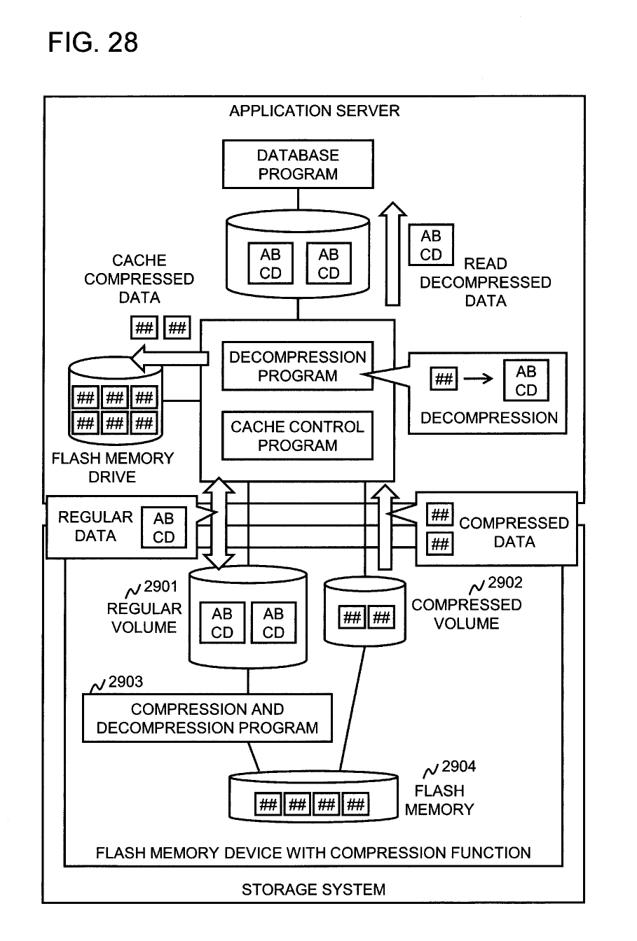

FIG. 28 is a view showing the outline of embodiment 2. The flash memory device with compression function provides two volumes, a regular volume 2901 and a compressed volume 2902. The regular volume 2901 and the compressed volume 2902 are both virtual volumes. The normal writing and reading of data is performed via the regular volume 2901. When data is written into the regular volume 2901, a compression and decompression function 2903 compresses the written data and stores the same in the flash memory 2904. When data is written from the regular volume 2901, the compression and decompression function reads the compressed data from the flash memory 2904, decompresses the same, and transmits the decompressed data via the regular volume 2901 to the read source device.

On the other hand, the compressed volume 2902 is used when reading compressed data. The compressed volume 2902 is set so as to perform only reading and not writing. The compressed volume 2902 is a volume set so as to provide the compressed data written from the regular volume 2901 in the compressed state.

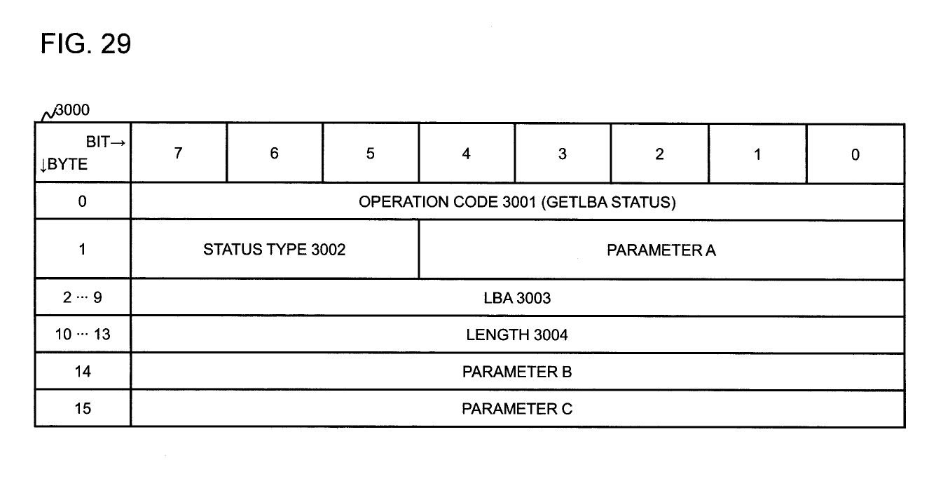

In other words, the regular volume 2901 and the compressed volume 2902 share the same logical areas, and share the virtual volume information of FIG. 11. By using a GET LBA STATUS request 3000 illustrated in FIG. 29, the relationship between the regular volume 2901 and the compressed volume 2902 can be acquired. Thus, the data written from the regular volume 2901 can be read in the compressed state from the compressed volume 2902.

FIG. 29 illustrates a GET LBA STATUS request 3000. The GET LBA STATUS request 3000 includes an operation code 3001, a compression volume information acquisition 3002, an LBA 3003, and a length 3004. The GET LBA STATUS request 3000 is a request for acquiring the status of the area designated by the LBA 3003 and the length 3004. Setting the status type 3002 to “1” means that the compressed status of the designated area and the area of the compressed volume corresponding to the regular volume can be acquired.

By changing the status type 3002, for example, it becomes possible to acquire the status of the tiers such as which tier is allocated to the designated area. The cache control program 404 designates the area from which the program wishes to acquire the compressed data in the LBA 3003 and the length 3004, sets the status type 3002 to “1” to acquire the compressed state, and transmits the GET LBA STATUS request 3000 to the storage controller 363 to thereby acquire the address of the compressed data. The storage controller 363 can transmit a similar request to the flash memory device 367 with a compression function in order to acquire the address of the compressed data.

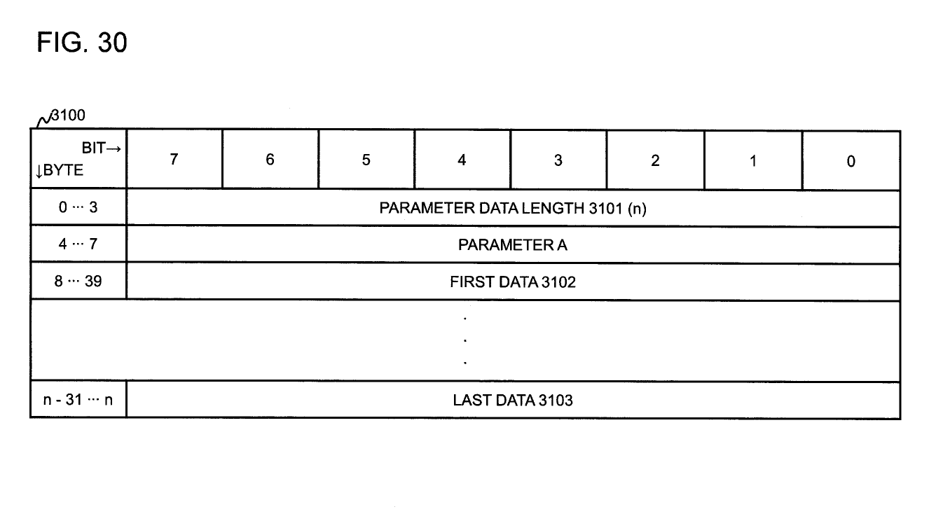

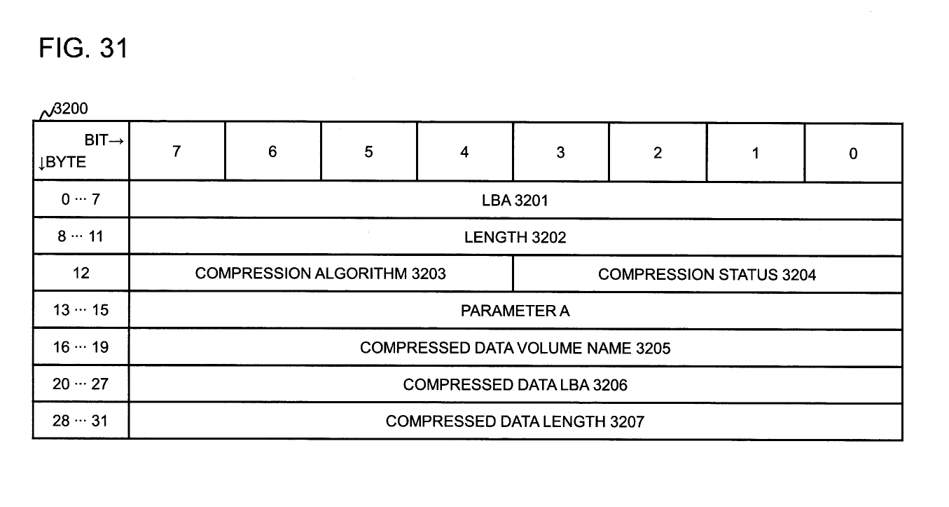

FIG. 30 shows the GET LBA STATUS response 3100. The GET LBA STATUS response 3100 is equipped with a parameter data length 3101 and a plurality of data 3102 and 3103. The GET LBA STATUS response 3100 is a response to the GET LBA STATUS request 3000. Data 3102 and 3103 are each a GET LBA STATUS response data 3200 illustrated in FIG. 31.

FIG. 31 illustrates a GET LBA STATUS response data 3200. The GET LBA STATUS response data 3200 includes an LBA 3201, a length 3202, a compression algorithm 3203, a compression status 3204, a compressed data volume name 3205, a compressed data LBA 3206, and a compressed data length 3207. When the compression status 3204 is set to “1”, the area specified by the LBA 3201 and the length 3202 is compressed via the algorithm designated by the compression algorithm 3202, and the compressed data is stored in the area specified by the compressed data volume name 3205, the compressed data LBA 3206 and the compressed data length 3207.

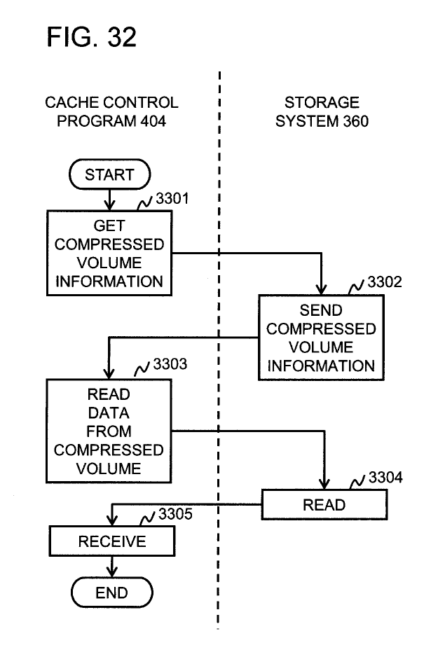

FIG. 32 shows a flow of the process when the cache control program 404 reads data from the storage system 360. In step 3301, in order to acquire the compressed state of the read destination area and the association between the read destination area and the area of the compressed volume 2902 by acquiring the GET LBA STATUS response 3100 and the GET LBA STATUS response data 3200, the cache control program 404 transmits the GET LBA STATUS request 3000 to the storage system 360. The read target area is designated in the LBA 3003 and the length 3004.

In step 3302, the storage system 360 transmits the GET LBA STATUS response 3100 and the GET LBA STATUS response data 3200 to the cache control program 404. In step 3303, the cache control program 404 reads the compressed data from the compressed volume. Since compressed data is stored in the area specified by the compressed data volume 3205, the compressed data LBA 3206 and the compressed data length 3207, a read request 1700 setting this area as the read target is transmitted to the storage system 360.

In step 3304, the storage system 360 reads the target data. In step 3305, the cache control program 404 reads the data. Unless data is written to the regular volume 2901, the association between the regular volume 2901 and the compressed volume 2902 will not change. Therefore, if the acquired association between the regular volume 2901 and the compressed volume 2902 is retained in the cache control program 404, steps 3301 and 3302 can be omitted every time the cache control program 404 reads data from the storage system 360. It is also possible to perform steps 3301 and 3302 every time the cache control program 404 reads data from the storage system 360.

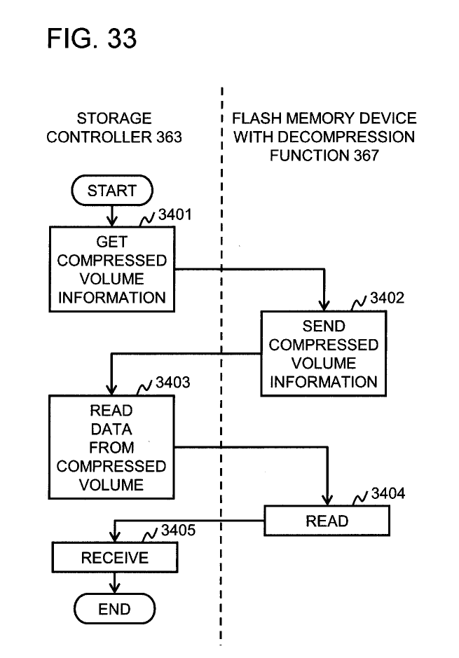

FIG. 33 shows the flow of the process when the storage controller 363 reads data from the flash memory device 367 with a compression function. In step 3401, the storage controller 363 transmits a GET LBA STATUS request 3000 to the flash memory device 367 with a compression function, so as to acquire the GET LBA STATUS response 3100 and the GET LBA STATUS response data 3200 to obtain the compression status of the read destination area and the relationship between the read destination area and the area in the compressed volume 2902. The read target area is designated in the LBA 3003 and the length 3004.

In step 3402, the flash memory device 367 with a compression function transmits the GET LBA STATUS response 3100 and the GET LBA STATUS response data 3200 to the storage controller 363. In step 3403, the storage controller 363 reads the compressed data sent from the compressed volume. Since compressed data is stored in the area specified by the compressed data volume 3205, the compressed data LBA 3206 and the compressed data length 3207, a read request 1700 designating this area as the read target is transmitted to the storage system 360.

In step 3304, the flash memory device 367 with a compression function reads the target data. In step 3305, the storage controller 363 receives data. If the storage controller 363 retains the relationship between the regular volume 2901 and the compressed volume 2902 acquired as described above, it becomes possible to omit steps 3401 and 3402. It is also possible to perform steps 3401 and 3402 every time the storage controller 363 reads data from the flash memory device 367 with a compression function.

According to embodiment 2, the compression and decompression of data is performed by the flash memory device 367 with a compression function, but the compression can also be performed by the storage controller 363. In this case, similar to embodiment 1, the storage controller 363 executes decision 2802 and step 2803 which are compression processing performed when data is written.

According to the configuration of embodiment 2, the application server 300 can read without performing decompression the data compressed by the flash memory device 367 with a compression function without changing the read request.

### Embodiment 31

Now, we will describe embodiment 3. In the present embodiment, the efficiency of use of the cache can be enhanced by preventing the same data from being stored in duplicated manner to the cache.

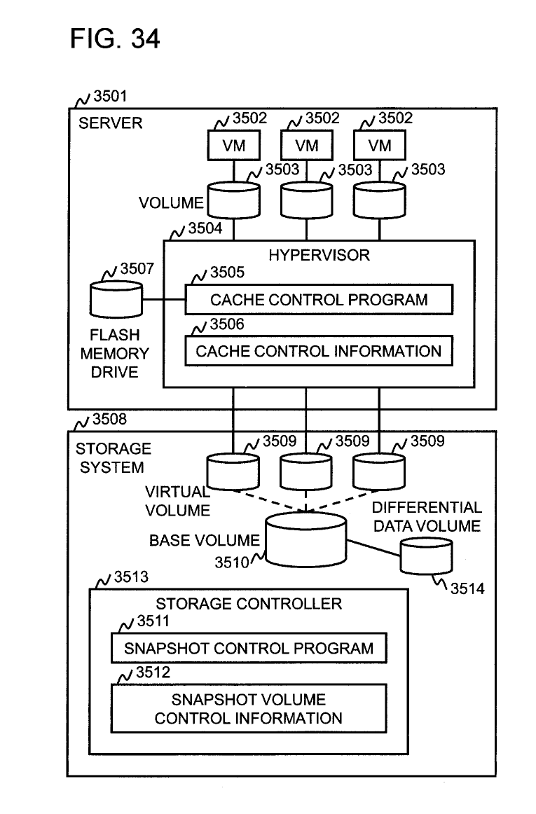

FIG. 34 illustrates the configuration of a computer system according to embodiment 3. The present computer system includes a server 3501 and a storage system 3508. A VM (Virtual Machine) 3502 is a virtual machine operating on a hypervisor 3504. The VM 3502 operates the OS and the program stored in a volume 3503. The hypervisor 3504 activates the VM 3502.

The cache control program 3505 caches the data that the VM 3502 writes to or reads from the storage system 3508 into the flash memory drive 3507, and when the VM 3502 accesses the cached data, the data is read from the flash memory drive 3507. The cache control information 3506 is information that the cache control program uses for cache control.

The storage controller 3513 controls the volume according to the read request and the write request from the server 3501. A virtual volume 3509 is the snapshot volume arranged for each VM 3502. A base volume 3510 is associated with a plurality of virtual volumes 3509, and stores OS images and application templates. The writing of data to the virtual volume 3509 is not performed to the base volume 3510, and the differential data between the base volume 3510 is stored in the differential data volume 3514. Upon reading data from the virtual volume 3509, if the reading is performed from the area where writing to the virtual volume 3509 has been performed, the differential data is read from the differential data volume 3514, and if not, the data is read from the associated area of the base volume 3510.

A snapshot control program 3511 controls accesses to the virtual volume 3509. A snapshot volume control information 3512 is information used by the snapshot control program 3511 for controlling the snapshot volume, which shows the area of the virtual volume 3509 and the relationship between the base volume 3510 and the differential data volume 3514.

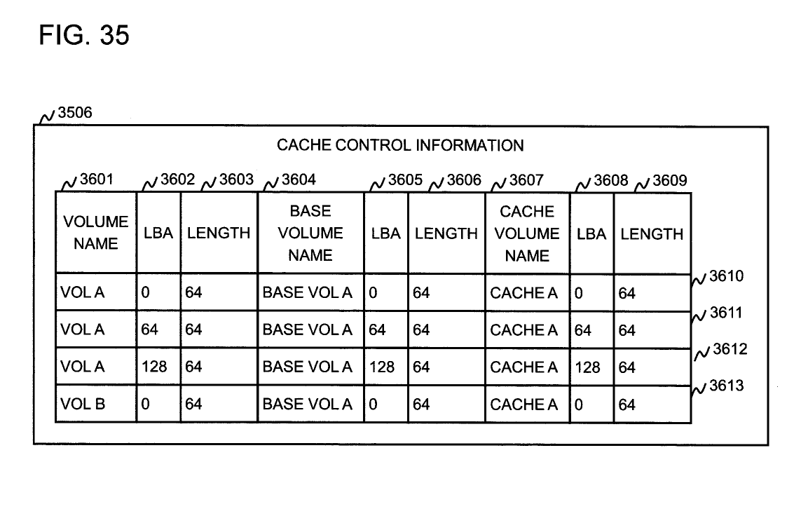

FIG. 35 shows the cache control information 3506 in the server 3501. A cache volume name 3607 indicates a flash memory drive 3507 in the server 3501. An area serving as the source of the area specified by the volume name 3601, the LBA 3602 and the length 3603 is defined via a base volume name 3604, an LBA 3605 and a length 3606. If the area specified by the volume name 3601, the LBA 3602 and the length 3603 is cached, the cache destination area is defined by the cache volume name 3607, the LBA 3608 and the length 3609.

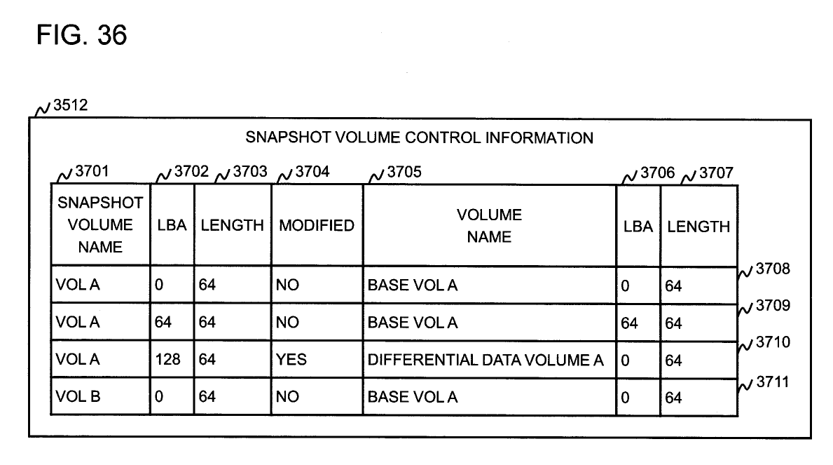

FIG. 36 illustrates a snapshot volume control information 3512. The snapshot volume control information 3512 includes a snapshot volume name 3701, an LBA 3702, a length 3703, a modified flag 3704, a volume name 3705, an LBA 3706 and a length 3707. The snapshot volume control information 3512 shows the relationship between the area of the snapshot volume 3509 and the area of the base volume 3510, and the area of the differential data volume 3514.

The area specified by the volume name 3601, the LBA 3602 and the length 3603 is the area in the volume 3509, which shows that the area is associated with the area specified by the volume name 3705, the LBA 3706 and the length 3707. The modified flag 3704 indicates whether write access to the area specified by the volume name 3601, the LBA 3602 and the length 3603 has occurred or not. If “No” is entered in the modified flag 3704, it means that there has not been any write access, and that the area is associated with the base volume 3510. If “Yes” is entered in the modified flag 3704, it means that there has been a write access, and that the area is associated with the differential data volume 3514.

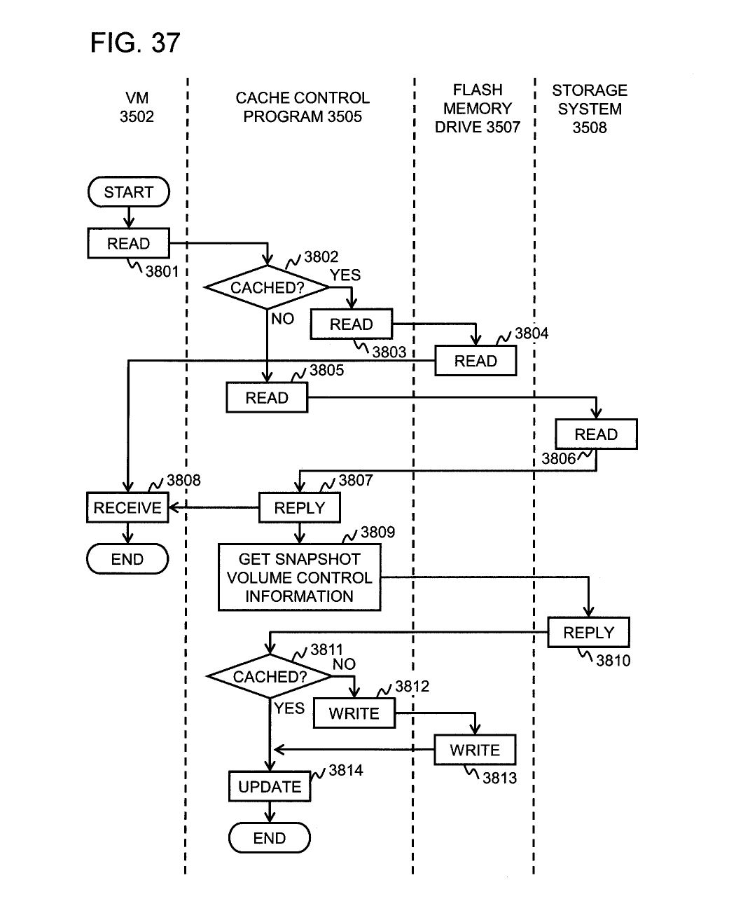

FIG. 37 shows the flow of the process when the VM 3502 performs a read processing. In decision 3801, the VM 3502 transmits the read request to the cache control program 3505. In step 3802, the cache control program 3505 refers to the cache control information 3506, and determines whether the read destination area is cached or not. If the area is cached, the procedure advances to step 3803, and if not, the procedure advances to step 3805. In step 3803, the cache control program 3505 transmits a read request to the flash memory drive 3507.

In step 3804, the flash memory drive 3507 reads in data, and transmits the same to the cache control program 3505. In step 3805, the cache control program 3505 transmits the read request to the storage system 3508. In step 3806, the storage system 3508 reads in data. In step 3807, the cache control program 3505 transmits the data to the VM 3502. In step 3808, the VM 3502 receives the data.

In step 3809, the cache control program 3505 acquires a snapshot volume control information 3512. According to an example of the acquisition method, the status type 3002 of the GET LBA STATUS request 3000 is set to “2” and the present request is transmitted to the storage system 3508. In step 3810, the storage transmits the snapshot volume control information 3512 to the cache control program 3505. According to an example of the transmission method, the area of the base volume associated with the area of the snapshot volume is designated in the compression data volume name, the compressed data LBA 3206 and the compressed data length 3207 of the GET LBA STATUS response data.

In decision 3811, the area of the base volume is obtained from the snapshot volume control information 3512 acquired in step 3810, and in step 3805, whether the read area is cached or not is confirmed by referring to the cache control information 3506.

In step 3805, if the modified flag 3704 of the read area is set to “No” and the area specified by the volume name 3705, the LBA 3706 and the length 3707 is in another row, it means that the same data has already been cached, so that the procedure advances to step 3814. In step 3805, if the modified flag 3704 of the read area is set to “No” but the area specified by the volume name 3705, the LBA 3706 and the length 3707 does not exist in another row, or if the modified flag 3704 is “Yes”, it means that the target data has not been cached, so that the procedure advances to step 3812 to cache the data.

In step 3812, the cache control program 3505 writes data into the flash memory drive 3507 to cache the same. In step 3813, the flash memory drive 3507 writes data. In step 3814, the cache control information 3506 is updated, and the position of the cached data is recorded.

According to embodiment 3, the snapshot volume control information 3512 is referred to during the read processing to determine whether to cache the read data, but it is also possible to cache all the read data, and delete the data cached in an overlapped manner at a given timing when the snapshot volume control information 3512 is acquired.

According to embodiment 3, the volume 3509 is a snapshot of the base volume 3510, and excluding the area where data has been written in, the data of the volume 3509 are the same. Using this information, by not caching the data in areas stored in different virtual volumes but associated to the same area, it becomes possible to efficiently utilize the limited capacity of the flash memory drive 3507.

### REFERENCE SIGNS LIST

300: Application server
306: Flash memory drive
360: Storage system
402: Database program
404: Cache control program
408: Decompression program
607: Compression program

1. A computer system comprising a server and a storage system having a compression function; wherein
the server includes a control unit and a cache; and
the storage system has a storage area provided by a plurality of storage devices;
wherein when a designated data of a received read request is already stored in the cache, the control unit of the server returns the stored data as a response to the read request; and
when the designated data is not stored in the cache, the control unit acquires the designated data compressed via the compression function and stored in the compressed state in the storage area from the storage system as it is in the compressed state, decompresses the acquired compression data, and returns the same as a response to the read request.

2. The computer system according to claim 1, wherein
when the designated data of the received read request is stored in a compressed state in the cache, the control unit of the server decompresses the stored data and returns the same as a response to the read request.

3. The computer system according to claim 1, wherein
when the designated data is not stored in the cache, the designated data acquired from the storage system as it is in the compressed state is stored to the cache.

4. The computer system according to claim 1, wherein
when the designated data is an object required to be compressed in advance, the designated data acquired from the storage system as it is in the compressed state is stored to the cache; and
when the designated data is an object not required to be compressed in advance, the designated data is decompressed and stored to the cache.

5. The computer system according to claim 1, wherein
when a number of accesses to data stored in a compressed state in the cache exceeds a given value, the data is decompressed and stored again to the cache.

6. The computer system according to claim 1, wherein
the control unit of the server returns a notice of completion of a write request without storing the designated data of the received write request to the cache.

7. The computer system according to claim 6, wherein
when the designated data of the write request is an object determined in advance as compression unnecessary, the designated data is stored to the cache.

8. The computer system according to claim 1, wherein
the plurality of storage devices in the storage system includes a flash memory device; and
the compression function of the storage system is realized by a control unit of the flash memory device.

9. The computer system according to claim 1, wherein
the control unit of the server inserts a flag requiring reading of data as it is in the compressed state to the read request; and
the storage system having received the read request including the flag transmits the compressed data to the server.

10. The computer system according to claim 1, wherein
the storage system provides a mutually associated first virtual volume and second volume to a first storage area which forms a part of the storage area;
a designated data of a write request to the first virtual volume is compressed via the compression function and stored to the storage area associated with the first virtual volume;
when the read request designates the second virtual volume, the control unit of the server acquires the compressed and stored designated data as it is in the compressed state; and
when the read request designates the first virtual volume, the control unit of the server acquires the compressed and stored designated data in a decompressed form.

11. The computer system according to claim 10, wherein
the control unit of the server acquires a correspondence relationship between the second virtual volume and the first virtual volume prior to processing the read request.

12. A computer system having a server and a storage system, wherein
the server includes a control unit and a cache, and provides a plurality of virtual machines;
the storage system provides a plurality of virtual volumes each associated with each of the plurality of virtual machines, and one base volume and a differential volume associated with the plurality of virtual volumes; and
wherein the differential volume stores a change data of the data stored in the base volume by the virtual machine associated with the plurality of virtual volumes;
when data stored in a designated area of a read request from the one virtual machine is not stored in the cache, a correspondence relationship information between the virtual volume, the base volume and the differential volume is acquired from the storage system; and
if it is determined based on the correspondence relationship information that the data designated by the read request is already stored in the cache, the data will not be stored in the cache.

13. A method for controlling a computer system comprising a server and a storage system having a compression function; wherein
the server includes a control unit and a cache;
the storage system has a storage area provided by a plurality of storage devices;
wherein when a designated data of a received read request is stored in the cache, the control unit of the server returns the stored data as a response to the read request; and
when the designated data is not stored in the cache, the control unit acquires the designated data compressed via the compression function and stored in the storage area from the storage system in the compressed state, decompresses the acquired compression data, and returns the same as a response to the read request.

14. The method for controlling a computer system according to claim 13, wherein
when the designated data is not stored in the cache, the designated data acquired from the storage system as it is in the compressed state is stored to the cache.

15. The method for controlling a computer system according to claim 13, wherein
when the designated data is an object determined in advance to be compressed, the designated data acquired from the storage system as it is in the compressed state is stored to the cache; and
when the designated data is an object not determined in advance to be compressed, the designated data is decompressed and stored to the cache.

16. The method for controlling a computer system according to claim 13, wherein
when a number of accesses to data stored in a compressed state in the cache exceeds a given value, the data is decompressed and stored again to the cache.
